(19) United States
(12) Patent Application Publication
(10) Pub. No.: US 2022/0073828 A1
(43) Pub. Date: Mar. 10, 2022

(54) All-Steam Gasification with Solid Fuel Preparation System

(71) Applicant: Wormser Energy Solutions, Inc., Lancaster, MA (US)

(72) Inventors: Douglas M. Todd, Galway, NY (US); John Parkes, Los Altos, CA (US)

(73) Assignee: Wormser Energy Solutions, Inc., Lancaster, MA (US)

(21) Appl. No.: 17/422,988

(22) PCT Filed: Jan. 21, 2020
(86) PCT No.: PCT/US20/14336

§ 371 Date: Jul. 14, 2021

Related U.S. Application Data
(60) Provisional application No. 62/795,663, filed on Jan. 23, 2019.

(51) Int. Cl. C10J 3/66; C10J 3/48; C10J 3/82

(52) U.S. Cl. CPC C10J 3/66; C10J 3/482; C10J 3/82; C10J 2200/09; C10J 2300/1807; C10J 2300/093; C10J 2300/0959; C10J 2300/0976; C10J 2200/152

(57) ABSTRACT

A carbonaceous fuel gasification system includes a micronized char preparation system comprising a transport reactor with a pulverizer function that receives solid carbonaceous fuel, hydrogen, oxygen, and fluidizing steam that produces micronized char, steam, and volatiles. An indirect gasifier includes a pressure vessel reactor comprising a dense bed of solids. A draft tube can be inside or outside the pressure vessel. A combustor provides heat for the gasification reaction by combustion of hydrogen and air and that provides products of combustion that flow through the draft tube. A distributor plate receives the micronized char, steam, and devolatilized hydrocarbons from the output of the micronized char preparation system. The indirect gasifier mixes the micronized char with steam at a temperature that converts them to syngas comprising hydrogen and carbon monoxide.

### CROSS REFERENCE TO RELATED APPLICATION

The present application is a non-provisional of U.S. Provisional Application Ser. No. 62/795,663, entitled “All-Steam Gasification with Solid Fuel Preparation System”, filed on Jan. 23, 2019. The present application is also related to U.S. patent application Ser. No. 15/227,137, entitled “All-Steam Gasification with Carbon Capture”, filed on Aug. 3, 2016, now U.S. Pat. No. 10,443,005; U.S. patent application Ser. No. 15/286,514, entitled “Method and Apparatus for Adiabatic Calcium Looping”, filed on Oct. 5, 2016; and U.S. patent application Ser. No. 15/868,334, entitled “All-Steam Gasification for Supercritical CO₂ Power Cycle System”, filed on Jan. 11, 2018. These U.S. Patent Applications are incorporated herein by reference.

### INTRODUCTION

Global warming concerns about CO₂ greenhouse gas accumulation in the atmosphere are increasing. The growth of fossil fuel consumption continues to rise. As such, there is a significant need for efficient and effective low-carbon technologies, especially for power generation and other applications.

Integrated gasification combined cycle (IGCC) technology is the cleanest way to make energy from coal. Gasification results in significantly fewer pollutants than produced by conventional coal power plants. An IGCC power plant burns syngas in a turbine to produce electricity. The excess heat is captured to power a second turbine that produces more electricity, resulting in high-efficiency power generation. Gasification of various solid fuels to produce chemicals including fertilizers, methanol, diesel fuel, and many other chemicals is common today. Gasification is beneficial to the environment, resulting in less pollution, reduced carbon dioxide emission, less solid waste, and lower water use. More efficient, smaller, and lower cost gasification systems are needed to ensure effective IGCC systems are available for future generation plants of various types. These generation systems also benefit from effective carbon capture and can benefit from integration with supercritical CO₂ power cycle technology that supports high-efficiency, low cost power generation with a reduction in plant footprint.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. The drawings are not intended to limit the scope of the Applicant's teaching in any way.

FIG. 1 illustrates a system block diagram of an all-steam gasification with carbon capture system according to the present teaching.

FIG. 2 illustrates a system block diagram of an all-steam gasification system with air-based combustion for a generic supercritical CO₂ power cycle with carbon capture system according to the present teaching.

FIG. 3 illustrates a system block diagram of an all-steam gasification system with oxygen-based combustion for a generic supercritical CO₂ power cycle with carbon capture system according to the present teaching.

FIG. 4 illustrates an embodiment of a devolatilizer and gasifier system 400 that includes a devolatilizer 402 that provides volatiles and micronized char directly to a gasifier 406 according to the present teaching.

FIG. 5 illustrates an embodiment of an indirect gasifier according to the present teaching.

FIG. 6 illustrates an embodiment of a products-of-combustion system for polygeneration applications according to the present teaching.

### DESCRIPTION OF VARIOUS EMBODIMENTS

The present teaching will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings can be performed in any order and/or simultaneously as long as the teaching remains operable. Furthermore, it should be understood that the apparatus and methods of the present teachings can include any number or all of the described embodiments as long as the teaching remains operable.

Global warming and climate change issues are requiring that coal power plants world-wide add expensive controls to capture and store CO₂ in order to meet desired emission rates. Current technologies, such as Integrated Gasification Combined Cycle (IGCC) with carbon capture for coal plants have proven uneconomical without subsidies. The additional power required to run the carbon capture systems reduces efficiency, and consequently widespread adoption has not occurred. This has led to the shutdown of older coal plants and cancellation of many new plants. Still, many experts believe that coal is a valuable energy source to assist in transitioning the world to renewable energy sources.

The present teaching relates to a small footprint and efficient all-steam gasification system with carbon capture, which can hasten widespread adoption of the beneficial IGCC technology. All-Steam Gasification (ASG) with an indirect gasifier, using micronized char as its feed is advantageous because it can supply oxygen for gasification from water releasing hydrogen to mitigate CO₂ emissions from the Power Block while producing syngas without nitrogen for the Power Block. Since hydrogen is the carbon-free fuel needed with carbon capture, the increased yield of hydrogen increases IGCC plant efficiency, from about 32% for a conventional system with carbon capture, to about 43% Higher Heating Value (HHV) with the new system. Due to unique designs in each of the subsystems, there is also an even greater reduction of cost, for both fuel and capital.

All-steam gasification has been used in, for example, combined gas and steam (COGAS), char-oil energy development (COED). Also, CO₂ Acceptor Process systems use steam gasification as well as many Biomass Gasifiers. However, these systems do not use hydrogen for heat or combine carbon capture applications with energy. The efficiency with carbon capture in an all-steam gasification and carbon capture system of the present teaching is as high as that of the most efficient coal power plants using conventional technology, without carbon capture. The all-steam gasification and carbon capture system of the present teaching applies to various types of solid fuels, such as coal and biomass.

One feature of the present teaching is that it can also be used with supercritical CO₂ power cycles. Supercritical CO₂ is a fluid state of carbon dioxide maintained within the critical pressure and temperature range. In these ranges, the gas acts as both a liquid and a gas simultaneously. Supercritical CO₂ has many desirable features. Supercritical CO₂ flows like a gas, but behaves like a liquid. Supercritical CO₂ reaches a supercritical state at moderate conditions. Supercritical CO₂ is also less corrosive than steam and has favorable thermal stability as compared to steam, which helps to reduce the power system footprint. Also, supercritical CO₂ is single phase, so it requires only single pressure exhaust heat exchangers, which can significantly lower the cost of the power plant. Furthermore, supercritical CO₂ can interface with many different heat sources.

Supercritical CO₂ is a particularly good working fluid for power generating turbines. Power turbines based on supercritical CO₂ power cycles can replace steam cycles in a wide variety of power generation applications and can provide relatively high efficiency and relatively low cost of electricity with modest inlet temperatures.

As such, some embodiments of the present teaching utilize an all-steam gasification system, which integrates with a supercritical CO₂ power cycle. Such systems can substantially improve efficiency and thus will hasten widespread adoption of gasification with supercritical CO₂ power cycle technology where coal is the fuel of choice. Due to unique designs in each of the subsystems, there is also a great reduction of cost, for both fuel and capital.

Some embodiments of the all-steam gasification and carbon capture system of the present teaching produce hydrogen from coal or other feedstocks for electric power and/or production of various chemicals. Some embodiments produce nitrogen-free high hydrogen syngas for applications such as IGCC with Carbon Capture Storage (CCS), Coal-to-Liquids (CTL) and polygeneration plants. The term “polygeneration” as used herein refers to the ability to provide a multi-product capability. The all-steam gasification with solid fuel preparation system and method of the present teaching provides higher efficiency, lower cost, and a smaller footprint compared with known systems. In addition, the all-steam gasification with solid fuel preparation system and method of the present teaching is able to produce power and to produce polygeneration multi-products with the necessary economics for world-wide competitiveness while addressing the major challenges associated with global warming.

In addition, all-steam gasification produces a larger quantity of hydrogen per pound of coal or other feedstock compared with other known methods. Using air blown methods will eliminate the large expensive air separation plant for producing oxygen, normally used for such systems, therefore significantly improving efficiency and cost. Also, an indirect gasifier enables nitrogen-free hydrogen necessary for polygeneration of liquids and chemicals while maintaining power-only and CTL-only-modes by keeping air from mixing with the critical streams.

Another feature of the present teaching is the use of micronized char produced in a devolatilizer and a char preparation system that enables air gasification of the feedstock in less than a second. This significantly reduces the gasification plant size and provides increased capacity in modularized equipment. An adiabatic calcium looping system with integral water gas shift, using high temperature fixed beds and limestone-based sorbents enhances the overall carbon capture system. The result is pipeline-quality, high-pressure CO₂. The high-temperature process enables heat from a shift reactor to be recovered at high temperature. This produces much more valuable steam than a lower-temperature shift used in prior art conventional shift systems. Systems according to the present teaching, such as those proposed by Wormser Energy Solutions Inc., the assignee of the present application, can avoid the need for steam to regenerate the sorbents used to capture carbon dioxide. Integrated high temperature heat recovery systems using specialized high temperature heat exchangers support the overall system with very high efficiency. Finally, such systems utilize known warm-gas clean-up systems that produce near-zero emissions, easing air pollution while reducing temperature cycling. Adding a warm-gas clean-up system leverages the normal capability of syngas cleanup at higher temperature to fit the high temperature adiabatic calcium looping (ACL).

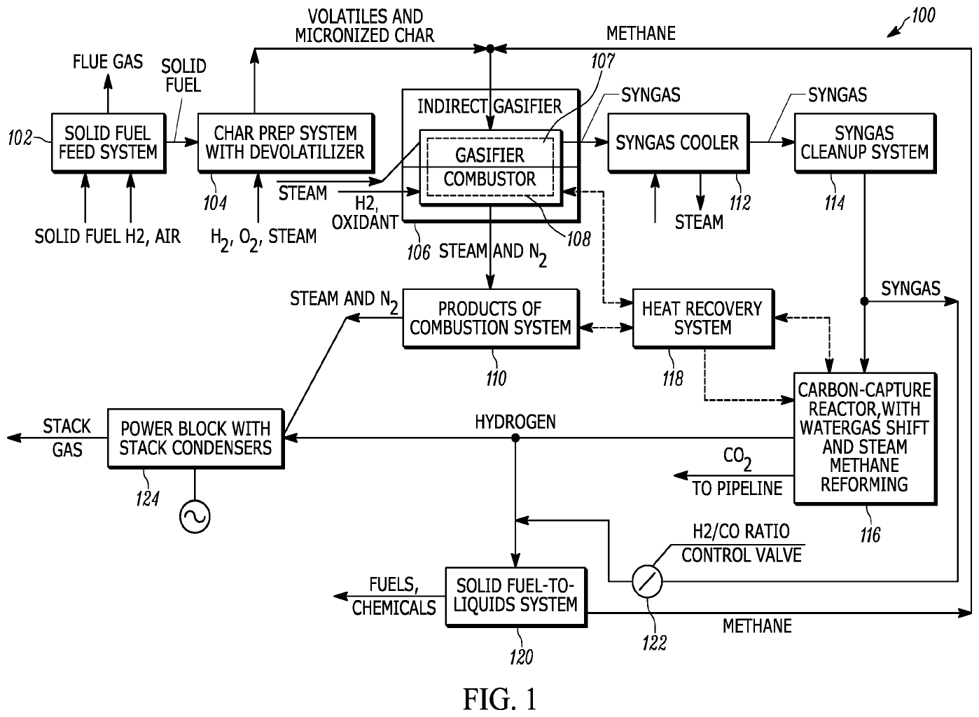

FIG. 1 illustrates a system block diagram of an all-steam gasification with carbon capture system 100 according to the present teaching. The all-steam gasification with carbon capture system 100 is suitable for use in polygeneration. In polygeneration, either power or chemicals or both are made from solid fuels, such as coal. Although many aspects of the present teaching are described in connection with the use of coal, one skilled in the art will appreciate that the present teaching is not limited to coal and that numerous other solid fuels can also be used. For example biomass, peat, wood, wood pellets, and charcoal can be used. The all-steam gasification with carbon capture system 100 may also be used for a single purpose.

The embodiment of the all-steam gasification with carbon capture system 100 shown in FIG. 1 includes a solid fuel feed system 102 that takes in a solid fuel, such as coal. The solid fuel feed system 102 also can use hydrogen and air and emits flue gas. Some embodiments of the solid feed system 102 use a rotary valve feeder or a dry solids feed pump and a fluid bed coal drier with a mixer. The solid feed system 102 provides solid fuel to a char preparation system with devolatilizer 104. Some embodiments of the char preparation system with devolatilizer 104 include a devolatilizer, char cooler/steam heater, let-down valve, pulverizer, electrostatic separator, air lock and syngas char conveyer.

One aspect of the present teaching is the realization of the advantages of using a char preparation system with devolatilizer 104 that utilizes a transport reactor that includes a pulverizing function. Embodiments operating as a transport reactor and including a pulverizing function eliminate the need for a counter-flow char cooler, a pressure let-down valve, a pulverizer, and an airlock. Also, embodiments of the char preparation system with devolatilizer 104 provide volatiles and micronized char together at an output. That output can be fed directly into a downstream indirect gasifier 106.

One feature of the present teaching is the production of micronized char that advantageously speeds the gasification process and reduces system contamination. The char preparation system 104 prepares micronized char from the solid fuel received from the solid fuel feed system 102, and transfers it to the indirect gasifier 106. In embodiments where the solid fuel is coal, the char preparation system 104 may receive crushed coal with a size suitable for fluidization. In some embodiments, the fluidization size is less than ¹/₄-inch.

Although it is possible to gasify coal or other solid fuel directly without using a char preparation system 104, it is preferable in some systems to first convert the coal into char and then gasify the char in the indirect gasifier 106. This is because char is much more brittle than coal since most of the interior of the coal particles have been hollowed out by pyrolysis. Pyrolysis produces char particles with a range of geometries. Char particle geometry may comprise a thin-shell sphere. The char particles can also be “Swiss cheese” like in geometry with holes through part of all of the material. The hollowed-out geometry causes char particles to break into far smaller pieces than coal. Particles below eight microns are readily achieved. For example, some particles of pulverized char can be ten-times smaller in diameter. The small size of micronized char particles (10-20 Microns) hastens gasification. A second feature of using micronized char of the present teaching is that it has non-wetting characteristics. Micronized char is non-wetting because the particles remain entrained in the gases in which they flow, rather than colliding with each other or other surfaces.

One feature of the present teaching is that, in some embodiments, the micronized char is provided directly to the indirect gasifier together with the volatiles generated in the devolatilizer. The indirect gasifier 106 of the present teaching produces syngas from the micronized char. Indirect gasifiers 106 are commonly used. As illustrated in FIG. 1, the heat for the reactions in indirect gasifier 106 is created by combustion in one chamber108, and gasification in the other chamber 107 of a gasifier/combustor 108. The combustion chamber 108 may also be referred to as a combustor. The gasifier chamber 107 may also be referred to as a gasifier. The gases emerging from each chamber are kept separated. The heat transfer between the chambers required for gasification is provided by circulating hot solids. The hot solids are heated in the combustor chamber 108 thereby providing heat to the gasifier chamber 107. In some embodiments, the hot circulating solid is flowing refractory sand.

Indirect gasification can eliminate the need for an oxygen plant also known as an air separation unit (ASU) while still producing nitrogen free syngas for fuels production in the all-steam gasification with carbon capture system described in connection with FIG. 1. This is because the products of combustion are kept separate from the syngas, thereby avoiding the contamination of the syngas by nitrogen in the combustion air. Indirect gasification is advantageous because it provides an improvement in both the efficiency and the costs of gasification systems used to produce chemicals. An additional feature of using embodiments of the indirect gasifier 106 described herein that use coal as a solid fuel is that the use of hydrogen in the combustion chamber for providing gasification heat by complete combustion allows all the carbon in the coal to be used to produce syngas fuel.

The gasifier chamber 107 takes in steam and micronized char and volatiles from the char preparation system 104. These elements are used in the gasifier. The combustor chamber 108 takes in oxidants and H₂. The gasifier chamber 107 can also use methane from the solids-fuel-to-liquids system 120. The combustor chamber 108 produces steam and nitrogen as products of combustion and supplies them to a products of combustion system 110. The indirect gasifier 106 produces syngas that is provided to a syngas cooler 112. The syngas cooler 112 cools the hot syngas leaving the indirect gasifier 106 to temperatures suitable for the syngas cleanup system 114. The syngas cleanup system removes pollutants and sends the syngas to a carbon-capture reactor 116. The carbon-capture reactor 116 produces CO₂ that is sent to a pipeline. The carbon-capture reactor 116 also produces hydrogen and/or high-hydrogen syngas.

One feature of the present teaching is the efficient reuse of heat in the system. An integrated high temperature heat recovery system 118 provides the gasifier steam and also can provide throttle steam for a steam turbine used for power generation. The heat recovery system 118 efficiently recovers the high temperature heat from the water gas shift reaction in the carbon-capture reactor 116. In various embodiments, the heat recovery system 118 can be optimized for specific applications. In some embodiments, the indirect gasifier 106 uses heat provided by the heat recovery system 118. In some embodiments, the carbon-capture reactor 116 uses heat provided by the heat recovery system 118. The heat recovery system 118 efficiently recovers and reuses heat from the high-temperature systems in the all-steam gasification with carbon capture system 100 of the present teaching. Some embodiments of the heat recovery system 118 combine a char cooler, combustor products, hydrogen cooler, CO₂ cooler, syngas cooler, warm gas clean up unit heat exchangers, and gas turbine heat recovery steam generator.

One feature of the present teaching is the ability to produce chemicals, such as liquid fuels, methanol, ammonia, and urea, in addition to providing power. Hydrogen and/or high hydrogen syngas produced by the carbon-capture reactor 116 is sent to a solid-fuel-to-liquids system 120. In some embodiments, the solid-fuel-to-liquids system 120 uses a conventional

Fischer Tropsch converter.

In some embodiments, the solid-fuel-to-liquids system 120 advantageously provides an additional adjustment of the hydrogen-to-carbon-monoxide ratio by controlling the bypass around the carbon-capture reactor 116 using a control valve 122. This bypass control adjusts the hydrogen-to-carbon-monoxide ratio to accommodate the chemical requirements of the particular chemical that is desired to be produced. The more bypassed gas, the higher the CO to H₂ ratio, and vice versa. The methane may be recycled to the carbon-capture reactor 116 where it is steam-reformed into hydrogen. This recycling of the methane from the solid-fuels-to-liquids system 120 eliminates the costly separation techniques normally required, such as cryogenic cooling, to remove the methane from the product. The high hydrogen syngas produced by the carbon-capture reactor may be used in the same way as any other fuel in a combined cycle while mitigating the CO2 emissions.

In some embodiments of the system of the present teaching, the hydrogen from the carbon-capture reactor 116 is also sent to a power block 124. The power block 124 of the present teaching may use a stack condenser for the stack gas that advantageously recovers the moisture created by the combustion of the hydrogen. Because the amount of hydrogen going to the power block 124 and forming water is large, the stack condensers provide a system with very low water use compared to conventional IGCCs. The power block 124 advantageously uses steam and N₂ from the products of combustion system 110. Condensation is made feasible by the very low sulfur dioxide in the syngas due to the high efficiency of the syngas cleanup system 114. The very low sulfur dioxide content syngas advantageously eliminates the corrosion of the stack that would otherwise occur. The power block 124 of the present teaching may also feature a larger-sized steam turbine to accommodate the many steam sources other than the gas turbine heat recovery steam generator.

Air extraction from a gas turbine for process air flows is used in conventional Integrated Gasification Combined Cycle (IGCC). The optimal amount of air extraction depends on economic and operating considerations. Some embodiments of the power block 124 of the present teaching use a different amount of air extraction as compared to prior art power blocks. The power block according to the present teaching can use hydrogen as the principal fuel, allowing products of combustion system 110 flows of steam and nitrogen to be returned to the gas turbine in the power block 124 for moderating hydrogen flame temperature. As such, the optimum amount of air extraction is different from known IGCC air extraction systems. Embodiments of the power block 124 used for polygeneration applications, including heating, cooling and electricity production, will likely all use a different optimum amount of air extraction than prior art IGCC.

The all-steam gasification with carbon capture system 100 of FIG. 1 includes the key subsystems necessary to gasify a solid or liquid fuel. Solid fuel coal is described herein to illustrate aspects of the present teaching, but it is understood that numerous other solid fuels could be used. Furthermore, alternative embodiments may contain only some of the subsystems illustrated in the embodiment of FIG. 1, as is well known to those familiar with the state-of-the-art. For example, in embodiments in which power only is required, the solid-fuel-to-liquid system 120 is omitted. In embodiments that require only coal-to-liquid, or solid fuel-to-liquid, the power block 124 may be omitted depending up on the configuration.

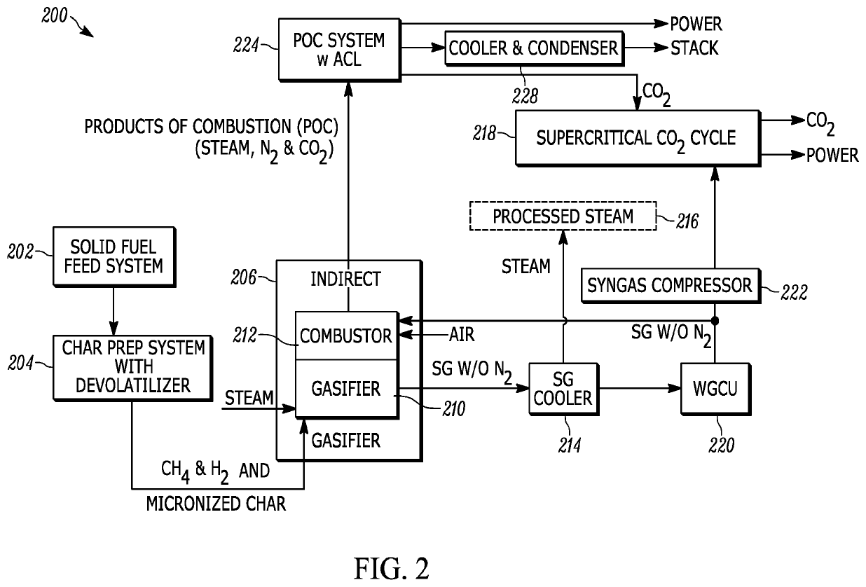

FIG. 2 illustrates a system block diagram of an all-steam gasification system with air-based combustion for a generic supercritical CO₂ power cycle with carbon capture system 200 according to the present teaching. Some embodiments of the solid fuel feed system 202 take in coal, H₂ and air, and emit flue gas. Also, some embodiments use a rotary valve feeder and a fluid bed coal drier with a mixer or a dry solids feed pump. The solid fuel feed system 202 provides solid fuel to a micronized char preparation system with devolatilizer 204. Also, some embodiments of the micronized char preparation system 204 can operate as a transport reactor that includes the pulverizing function which generates micronized char and volatiles at an output. The volatiles include CH₄ and H₂. Some embodiments of the micronized char preparation system 204 prepare micronized char from coal received from the solid fuel feed system 202, and transfer it to an indirect gasifier 206 with the volatiles. In some embodiments, the micronized char preparation system 204 receives crushed coal with a size suitable for fluidization. For example, fluidization sizes of less than ¼-inch are suitable. The devolatilizer has the capability to crack all the tars.

In one embodiment, the indirect gasifier 206 is an Internally-Circulating Fluidized Bed (ICFB) that uses a single pressure vessel reactor for combustion and gasification. Using a single pressure vessel reactor simplifies operation and reduces equipment size. The single pressure vessel reactor comprises a vertical tube, which is sometimes called a draft tube, at the center of the reactor. The flow of gases in the draft tube is upwards, while the flow of solids in the fluidized bed-of-dense-solids surrounding the draft tube is downwards. The fluidized bed-of-dense-solids is sometimes referred to as the annular bed and is typically configured to be deep enough to fully gasify the coal.

In one embodiment, the indirect gasifier combustor 212 operates by combusting fuel and air injected into an entrance of a draft tube to produce the heat required for the steam gasification reaction. For example, the fuel can be char, hydrogen or syngas. Using syngas or hydrogen eliminates the need for a cleanup system for the char combustion. The combustion reduces the density of the flowing stream, compared with that of the dense-fluidized-bed reactor surrounding it. This creates a pressure difference at the bottom of the draft tube that causes the bed-of-dense-solids in the annular section to flow downward where they are entrained by the gases flowing up the draft tube, thereby causing the continuous circulation of hot solids around inside the reactor.

The solids comprising the fluidized dense-bed-of-solids are a relatively high-density refractory sand, such as alumina. High-density solids provide a sufficient flow rate of the circulating solids to limit the temperature difference around the loop to an acceptable level, of about 200° F. The circulation flow can be as much as 50-times the flow of fuel, or syngas. The refractory sand is fine enough to be fluidized by the flow of syngas created from the steam and micronized char that enter through a distributor plate.

An ICFB indirect gasifier mixes micronized char with steam at a high-enough temperature to convert them to hydrogen and carbon monoxide. The heat of reaction is provided by the combustion of hydrogen or syngas and air in the combustor at the bottom of the gasifier. The products of combustion quickly mix with hot circulating solids flowing down into the mixer. The mixture of hot solids and the products of combustion then flow up through the draft tube. At its top, the solids fall back onto the surrounding fluidized dense-bed-of-solids, while the products of combustion exit through a vent at the top of the reactor. A funnel shape at the top of the draft tube allows a dilute bed to form that prevents the elutriation of particles into the freeboard. The heat of combustion keeps the bed material hot, to provide heat for gasification. Solids flow downwards while the char and steam, and then the hydrogen and carbon monoxide (syngas) formed from the steam-char reaction flow upwards.

Although it is possible to gasify coal directly without using a char preparation system 204, it is preferable in many systems to first convert the coal into char and then gasify the char in the indirect gasifier 206. This is because char is much more brittle than coal since most of the interior of the coal particles have been hollowed out by pyrolysis. Pyrolysis can produces char particles with a wide range of geometries. For example, the char particle geometry can be a thin-shell sphere. The char particles can also be a “Swiss cheese” like geometry as the hollowed-out geometry causes char particles to break into far smaller pieces when pulverized compared to coal. Particles below eight microns are readily achieved. The small size of pulverized char particles hastens gasification.

Another feature of using micronized char is that it can have non-wetting characteristics. Micronized char can be non-wetting because the particles remain entrained in the gases in which they flow, rather than colliding with each other or other surfaces. The non-wetting feature avoids the fouling, clinkering, agglomeration, and corrosion that is common in known coal-fired power systems that use pulverized coal as the solid fuel.

Some embodiments of the solid fuel gasification system of the present teaching include a micronized char preparation system with devolatilizer 204 that receives solid carbonaceous fuel, hydrogen, oxygen, and fluidizing steam and produces micronized char, steam, volatiles, and hydrogen. Some embodiments of the indirect gasifier 206 include a vessel comprising a gasification chamber 210, or gasifier, which receives the micronized char and volatiles from the micronized char preparation system 204, and which receives steam. Some embodiments of the gasification chamber 210 produce syngas, ash, and steam at one or more outlets.

Indirect gasification creates an improvement in both the efficiency and the costs of gasification systems used to produce power and chemicals. The indirect gasifier 206 also includes a combustor 212. The combustor 212 may also be referred to as a combustion chamber. Some embodiments of the combustor 212 receive and burn a mixture of syngas and air to provide heat for gasification and the POC system. In some embodiments, the heat for gasification is transferred from the combustor 212 to the gasifier 210 by circulating refractory sand.

The indirect gasifier 206 of the present teaching produces syngas from the micronized char. Prior art indirect gasifiers have been used to make methane and syngas from biomass. In some embodiments, the heat for the reactions in the indirect gasifier 206 is created by combustion in the combustor 212, and gasification in the gasifier 210. The gases emerging from each chamber are kept separated. The heat transfer between the chambers required for gasification is provided by circulating hot solids. The hot solids are heated in the combustor and cooled by gasification in the gasifier 210.

One feature of using an indirect gasifier 206 of the present teaching is that it makes all-steam gasification (ASG) possible. Furthermore, indirect gasification using air for combustion in the combustor 212 eliminates the need for a large oxygen plant, also known as an air separation unit (ASU), while facilitating fuels production and polygeneration. This is because the products of combustion are kept separate from the syngas, thereby avoiding the contamination of the syngas by nitrogen in the combustion air. Eliminating the need for an oxygen plant will reduce costs significantly and will also significantly reduce the footprint of the system. Some embodiments of indirect gasifiers 206 of the present teaching advantageously require less oxidant than prior art gasification systems. In one specific embodiment, the indirect gasifier 206 uses an oxygen supply that is approximately 5% of that required for a prior art oxygen blown gasification. In various embodiments, a wide range of percentage saving of oxygen and air supply compared to prior art gasification is realized.

The indirect gasifier 206 produces syngas at one output that is provided to a syngas cooler 214. Some embodiments of the syngas cooler 214 have an inlet coupled to the outlet of the gasifier 210 of the indirect gasifier 206, where the syngas cooler 214 cools the syngas, and generates steam at an outlet. The syngas cooler 214 provides processed steam 216.

The syngas cooler 214 includes a pressure vessel. In some embodiments, the syngas cooler 214 houses multiple fluidized beds that are supported by distributer plates with steam tubes embedded in the fluidized beds. The turbulence of a fluidized bed prevents the buildups that can occur in conventional fire tube heat exchangers. The use of more than one bed in the syngas cooler 214, with successive beds flowing upwards operating at lower temperatures, increases the efficiency of the steam turbine that utilizes the waste heat from the syngas cooler 214. Some embodiments of the syngas cooler 214 utilize a fluidized-bed cooler design that exhibits significantly higher heat transfer coefficients than a conventional fire tube cooler. The use of such a syngas cooler 214 reduces the heat exchanger's size and cost.

Some embodiments of the all-steam gasification system with air-based combustion for a generic supercritical CO₂ power cycle system with carbon capture system 200 use a syngas cleanup system 220 having an input that receives the cooled syngas from the outlet of the syngas cooler 214 to remove impurities. The syngas cooler 214 cools hot syngas leaving the indirect gasifier 206 to the temperature required by the syngas cleanup system 220. In some embodiments of the syngas cleanup system 220, a transport desulfurizer processes the syngas and then passed to a candle filter that removes ash. When needed, the syngas is passed to a polishing desulfurizer. A sorbent regenerator uses air from a boost air compressor to collect sulfur dioxide that is removed from the transport desulfurizer by a sorbent material. This sulfur dioxide can be sent to a direct sulfur converter to produce sulfur. Finally, a multi-contaminant scrubber is used to remove mercury, and ammonia, arsenic, and selenium as needed.

Some embodiments of the syngas cleanup system 220 of the present teaching use a Warm Gas Cleanup System (WGCU) as shown in FIG. 2, which was developed by Research Triangle Institute headquartered in the Research Triangle Park in North Carolina. This type of syngas cleanup system can remove essentially all pollutants, including sulfur, particulate matter, and trace elements, such as ammonia, mercury, selenium, and arsenic with high efficiencies. Using the WGCU will bring emissions below the strictest levels of EPA standards. Ammonia is also removed to minimize NOx emissions.

The syngas cleanup system 220 removes pollutants and sends the syngas to the syngas compressor 222. The syngas compressor 222 may be separate or be part of the supercritical CO₂ power cycle 218. The syngas compressor 222 compresses the syngas to a pressure and temperature that is appropriate for a supply input to the supercritical CO₂ power cycle 218. The supercritical CO₂ power cycle 218 produces carbon dioxide and power.

A second output of the indirect gasifier 206 provides products of combustion, steam, nitrogen and carbon dioxide, to a Product of Combustion (POC) system with adiabatic calcium looping (ACL) system 224. Adiabatic calcium looping product of combustion systems use adiabatic, adsorption, pressure-swing, and fixed bed carbon-capture systems for removing the carbon compounds from the syngas or products of combustion generated from the solid fuel. The term “adiabatic” refers to a process in which no heat is added to, or removed from, the sorbent. Instead, the heat for the reactions is provided or removed by changes in the temperature of the sorbent itself. This means that the sorbent heats up during carbonation and cools back to its original temperature during calcination, before the cycle is repeated.

Some embodiments of the POC with ACL system 224 of the present teaching remove the carbon dioxide from a pressurized stream of products of combustion from the indirect gasifier 206. In various embodiments, the POC with ACL system 224 of the present teaching is used to remove carbon dioxide. The combination of POC with the ACL system 224 according to the present teaching is sometimes referred to as POC with pressure-swing calcium looping. Pressure-swing calcium looping differs from known temperature-swing calcium looping systems that are sometimes used with post-combustion carbon capture systems where the two reactors are at the same pressure, but are at different temperatures. In temperature-swing calcium looping, typically two fixed bed reactors are used. Pressure-swing calcium looping overcomes many limitations of prior art temperature-swing systems. Pressure-swing calcium looping can negate the high attrition rate of the sorbent particles. Pressure-swing calcium looping does not require the use of oxygen to burn fuel which is inconvenient and expensive.

One advantage of the POC with ACL system 224 according to the present teaching is that it requires a relatively small equipment footprint. Embodiments of the adiabatic calcium looping apparatus of the present teaching are typically many times smaller than conventional air-blown equipment of the prior art. Other benefits of the POC with ACL system 224 according to the present teaching include providing relatively high plant efficiency and providing relatively high carbon-capture efficiency. Also, the sorbent used in the POC with ACL system 224 according to the present teaching is non-toxic, unlike the conventional amine sorbents used in known systems. Furthermore, these non-toxic sorbents do not require external regeneration with heat.

The POC with ACL system 224 according to the present teaching also avoids the need for steam to regenerate the sorbent. This is because calcium looping captures the carbon from the gases in one reactor (the “carbonator”), and releases carbon dioxide from the sorbent in a second reactor, (the “calciner”).

In addition, the POC with ACL system 224 according to the present teaching converts high temperature gas into power at an output. In some embodiments, the POC with ACL system 224 provides expander power (electric or mechanical). The POC with ACL system 224 provides steam to a stack via a cooler and condenser 228 at a second output. The POC with ACL system 224 also provides carbon dioxide to the supercritical CO₂ power cycle 218 at a third output. In some embodiments, the POC with ACL system 224 provides pure CO₂ stream in a range of about 3-28 PSI and at a temperature that is typically less than 1,800° F. to the supercritical CO₂ power cycle 218.

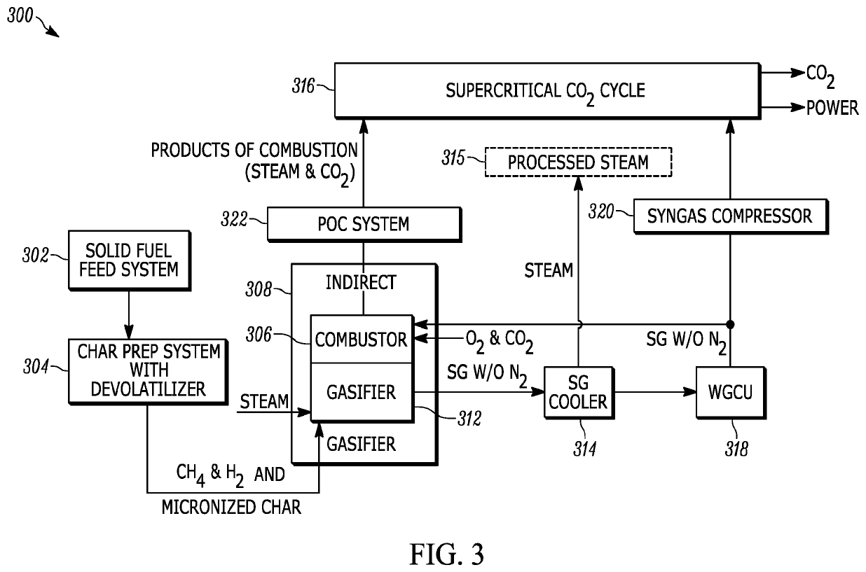

FIG. 3 illustrates a system block diagram of an all-steam gasification system with oxygen-based combustion for a generic supercritical CO₂ power cycle with carbon capture system 300 according to the present teaching. The embodiment of the all-steam gasification system with oxygen-based combustion for a generic supercritical CO₂ power cycle with carbon capture system 300 according to the present teaching shown in FIG. 3 is similar to the system illustrated in FIG. 2. However, in the all-steam gasification system with oxygen-based combustion for a generic supercritical CO₂ power cycle with carbon capture system 300 of FIG. 3, oxygen is supplied to a combustor rather than air as described in connection with FIG. 2. The oxygen needs a moderator such as CO₂.

A solid fuel feed system 302 is used to provide solid carbonaceous fuel to a micronized char preparation system 304. In some methods, the fuel is coal. The char preparation system 304 provides micronized char and volatiles (CH₄, H₂) to a gasifier 312 of an indirect gasifier 308. Some embodiments of the micronized char preparation system 304 can operate as a transport reactor that includes the pulverizing function which generates micronized char and volatiles at an output. The gasifier 312 provides syngas without nitrogen to a syngas cooler 314. The syngas cooler 314 generates process steam 315. The syngas cooler 314 provides cooled syngas without nitrogen to a warm gas clean-up (WGCU) 318. In various embodiments, the WGCU 318 removes contaminants such as particulates, sulfur compounds, hydrogen and other trace contaminants from the syngas. Syngas from the WGCU 318 is passed through a syngas compressor 320 and then provided to an input of the supercritical CO₂ power cycle 316. The syngas compressor 320 may also be part of the CO₂ power cycle 316.

The combustor 306 is supplied oxygen and syngas. Some embodiments supply syngas to the combustor 306 from the WGCU 318. In some embodiments, the oxygen is supplied by the same plant that supplies the supercritical CO₂ power cycle 316. In other embodiments, the oxygen is supplied by a separate air separation unit or other oxygen producing device.

The output of the indirect gasifier 308 supplies products of combustion to a products-of-combustion system (POC) 322. The POC System 322 can include an expander turbine to provide power. The output of the products-of-combustion system 322 is supplied to the supercritical CO₂ power cycle 316. In various embodiments, the products-of-combustion system 322 supplies the CO₂/Steam mixture at the appropriate conditions for the particular supercritical CO₂ power cycle.

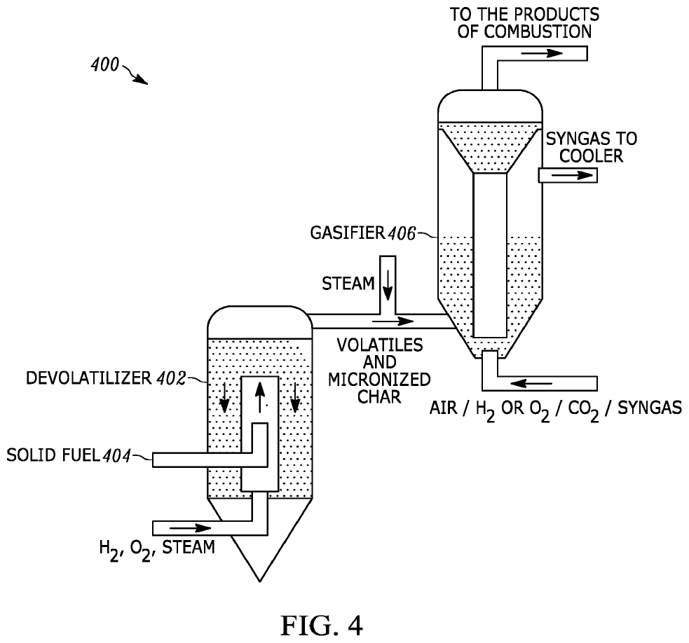

FIG. 4 illustrates an embodiment of a devolatilizer and gasifier system 400 that includes a devolatilizer 402 that provides volatiles and micronized char directly to a gasifier 406 according to the present teaching. The devolatilizer 402 takes in a solid fuel 404 and H₂, O₂, and steam. In some implementations including using a rotary valve, CO₂ is also received. The solid fuel 404 is heated by burning air/H₂ or O₂/CO2/syngas in the devolatilizer 402. The devolatilizer 402 can operate as a transport reactor that includes a pulverizing function. Volatiles and micronized char produced by the devolatilizer 402 are provided directly to the gasifier 406. The gasifier 406 sends products of combustion to the products-of-combustion system and then on to, for example, a power block.

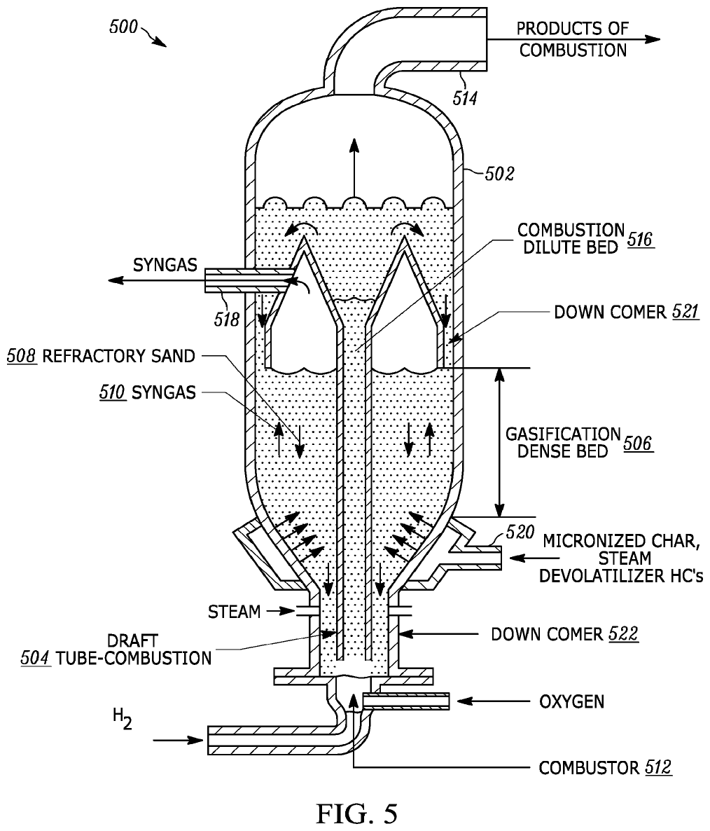

FIG. 5 illustrates an embodiment of an indirect gasifier 500 according to the present teaching. This particular embodiment of the indirect gasifier 500 shown in FIG. 5 is an internally-circulating fluidized bed (ICFB). The ICFB uses a single pressure vessel reactor 502 for combustion and gasification. This single pressure vessel reactor 502 simplifies operation and reduces equipment size. The pressure vessel reactor 502 comprises an optional vertical tube, also called a draft tube 504, at the center of the reactor. The flow of gases and solids in the draft tube 504 is upwards, while the flow of solids 508 in the downcomer 521 and fluidized bed-of-dense-solids 506 surrounding the draft tube 504, is downwards. The fluidized bed-of-dense-solids 506 is configured to be deep enough to fully gasify the coal, so that substantially all of the volatiles are released. However, it should be understood that some embodiments do not include the draft tube 504. In some of these embodiments, a draft tube is located outside of the pressure vessel.

Fuel and combustion air are injected into the entrance of the draft tube 504, which reduces the density of the flowing stream there, compared with that of the dense-fluidized-bed reactor surrounding it. This creates a pressure difference at the bottom of the draft tube that causes the bed-of-dense-solids 506 in the annular section to flow downward, where they are entrained by the gases flowing up the draft tube 504, thereby causing the continuous circulation of hot solids around inside the reactor 502. The bed-of-dense-solids 506 is sometimes referred to as the annular bed. The solids comprising the fluidized dense-bed-of-solids 506 are relatively high-density refractory sand 508, such as alumina. The high density of these materials increases the circulation rate, and therefore, the amount of heat than can be circulated. The circulation flow rate can be on order of 30-times the flow rate of the fuel (char). A high circulation rate is desirable as it limits the temperature change of the bed material as it flows from one section of the reactor to the other.

The indirect gasifier 500 mixes micronized char with steam, at a high-enough temperature to convert them to hydrogen and carbon monoxide. The heat of reaction is provided by the combustion of hydrogen and air in the combustor 512 at the bottom of the gasifier 500. The products of combustion quickly mix with hot circulating solids flowing down into the mixer. The mixture of hot solids and the products of combustion then flow up through the draft tube 504. At its top, the solids fall back onto the surrounding fluidized dense-bed-of-solids 506, while the products of combustion exit through the vent 514 at the reactor's top. A funnel shape at the top of the draft tube 504 allows a dilute bed 516 to form that prevents the elutriation of particles into the freeboard.

The heat of combustion keeps the bed material hot, thereby providing heat of gasification, which occurs in the annular bed, or dense-bed-of-solids 506. Solids flow downwards while the char and steam, and then the hydrogen and carbon monoxide (syngas) made from the steam-char reaction flow upwards. These upward flowing gases leave through the opening 518 in the side of the reactor 502. Care is taken that the two outlet streams exiting the vent 514 and the opening 518 never mix. Otherwise the nitrogen in the combustion air would contaminate the syngas, which is unacceptable in coal-to-liquids processes.

Circulation in the reactor 502 occurs because the density of the materials within the draft tube 504, which includes both gases and hot solids, is lower than that of the dense fluidized material in the dense-bed-of-solids 506 annular bed. This arrangement automatically sustains circulation. The circulating solids are made of high-density refractory sand 508, such as alumina to transfer the heat. The high density is needed to provide a sufficient flow rate of the circulating solids to limit the temperature difference around the loop to an acceptable level, such as about 200° F. The refractory sand 508 is fine enough to be fluidized by the flow of syngas 510 created from the steam, micronized char, and volatiles from a devolatilizer (not shown) that enter through the distributor plate 520.

In some embodiments, the preferred fuel for entering the draft tube 504 is hydrogen, as opposed to char. This is because using hydrogen eliminates the need for a cleanup system for the char combustion. In these embodiments, hydrogen with air is ignited in a combustor beneath the entrance of the draft tube, and then mixed with the flow of circulating hot solids. The products of combustion, air, and steam are then directed to the power block for multiple purposes.

The top of the draft tube 504 is sloped and extended across the area of the gasifier bed. This geometry both minimizes dead spots, and provides uniform flow across the fluidized bed. The injection of small amounts of steam into the upper down corner 521 prevents or limits the entrainment of products of combustion from being entrained into the syngas 510. The lower down corner 522 is similarly designed to avoid the entrainment products of combustion, by maintaining a flow rate that is sufficient to overcome the flow of countervailing gases. In various embodiments, any carbon dioxide that has formed in previous reactors of the all-steam gasification and carbon capture system of the present teaching may be absorbed and recovered in various alternative known carbon capture systems. It should be understood that some embodiments of the indirect gasifier do not rely on the draft tube 504.

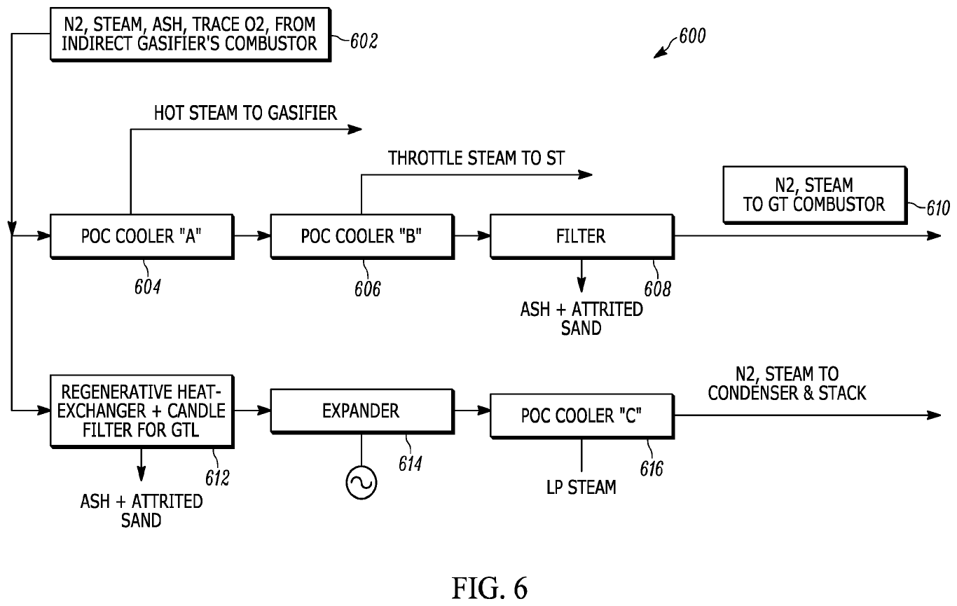

FIG. 6 illustrates an embodiment of a products-of-combustion system 600 for polygeneration applications according to the present teaching. This embodiment of a products-of-combustion system 600 could be used as the POC element in various systems according to the present teaching. For example, the products-of-combustion system 600 could be part or all of POC element 110 described in connection with FIG. 1, part of all of POC system with ACL 224 described in connection with FIG. 2, or part or all of POC conditioning 322 element described in connection with FIG. 3.

In the products-of-combustion system 600 for polygeneration applications, a stream of N₂, steam, ash, and trace O₂ from an indirect gasifier's combustor enters the combustion system 600. In the embodiment shown in FIG. 6, the stream 602 of nitrogen, steam and other materials is split into two streams. The split ratio is determined by the power and chemical requirements that are particular to the polygeneration application. The first stream flows through one or more coolers, such as coolers 604, 606. The first stream then flows to a filter 608 and on to the gas turbine 610. The first stream provides diluent for the hydrogen combustion thereby controlling NOx production and creating power augmentation.

The second stream, when not needed for power, is re-generatively cooled and filtered using a heat exchanger and candle filter system 612. The second stream is then decompressed in an expander 614 to produce power. The second stream may pass through a cooler 616 and then passes on to the stack. The moisture is condensed and recycled, while the nitrogen is vented into the atmosphere. The embodiment shown in FIG. 6 represents one example of a POC system that can be integrated with the all-steam gasification system according to the present teaching.

One feature of the present teaching is the recognition that it is possible to provide a substantial simplification to the system that generates and supplies micronized char to the gasifier as compared to known systems. Providing micronized char together with volatiles produced in a char preparation system that includes a devolatilizer having a pulverizing function directly to a gasifier substantially reduces the number of components, the system complexity, and the footprint of a solid fuel system that relies on all-steam gasification. In addition, providing micronized char together with volatiles produced in a char preparation system that includes a devolatilizer and a pulverizer directly to a gasifier provides for generations at multiple outputs, including power and/or chemicals, and can utilize carbon capture. These gasifier systems can also use hydrogen as a fuel, thus eliminating the need for a cleanup system for the char combustion. These features support simpler, smaller, and more efficient systems for clean power generation and polygeneration applications.

### Equivalents

While the Applicant's teaching is described in conjunction with various embodiments, it is not intended that the Applicant's teaching be limited to such embodiments. On the contrary, the Applicant's teaching encompass various alternatives, modifications, and equivalents, as will be appreciated by those of skill in the art, which may be made therein without departing from the spirit and scope of the teaching.

What is claimed is:

1. A carbonaceous fuel gasification system comprising:
a) a micronized char preparation system comprising a transport reactor with a pulverizer function that receives solid carbonaceous fuel, hydrogen, oxygen, and fluidizing steam to provide heat for devolatilization, the micronized char preparation system producing micronized char, steam, and volatiles at an output; and
b) an indirect gasifier, comprising a pressure vessel reactor comprising:
i) a draft tube in the pressure vessel;
ii) a dense bed of solids that surrounds the draft tube;
iii) a combustor positioned below the draft tube that provides heat for the gasification reaction by combustion of hydrogen and air and that provides products of combustion that flow through the draft tube and exit at a vent positioned in the pressure vessel; and
iv) a distributor plate that receives the micronized char, steam, and devolatilized hydrocarbons from the output of the micronized char preparation system,
wherein the indirect gasifier mixes the micronized char with steam at a temperature that converts them to syngas comprising hydrogen and carbon monoxide.

2. The carbonaceous fuel gasification system of claim 1 wherein the draft tube is formed in a funnel shape at a top section of the draft tube.

3. The carbonaceous fuel gasification system of claim 1 further comprising an opening positioned proximate to a top of the draft tube through which syngas produced by a steam-char reaction leaves the pressure vessel.

4. The carbonaceous fuel gasification system of claim 1 wherein an opening of the draft tube through which syngas produced by a steam-char reaction leaves the pressure vessel is positioned such that a fluid stream leaving the vent and a fluid stream leaving the opening never mix, thereby preventing air contamination of produced syngas.

5. The carbonaceous fuel gasification system of claim 1 wherein the indirect gasifier mixes the micronized char with steam at a temperature that converts them to syngas comprising nitrogen-free hydrogen and carbon monoxide.

6. The carbonaceous fuel gasification system of claim 1 further comprising a dilute bed of solids positioned proximate to the top of the draft tube.

7. The carbonaceous fuel gasification system of claim 1 wherein the dense bed of solids comprises refractory sand.

8. The carbonaceous fuel gasification system of claim 1 wherein the dense bed of solids comprises alumina.

9. The carbonaceous fuel gasification system of claim 1 wherein a density of the dense bed of solids is chosen to provide a flow rate of circulating solids that limits a temperature difference around a loop of circulating solids to less than 200° F.

10. The carbonaceous fuel gasification system of claim 1 wherein the pressure vessel is configured so that a circulation rate of the dense bed of solids is greater than a char fee rate.

11. The carbonaceous fuel gasification system of claim 1 wherein the pressure vessel is configured so that a circulation rate of the dense bed of solids is up to 30 times greater than the char feed rate.

12. The carbonaceous fuel gasification system of claim 1 wherein the draft tube is positioned centrally in the pressure vessel.

13. The carbonaceous fuel gasification system of claim 1 wherein the micronized char preparation system is configured to utilize O₂/CO₂/syngas to produce the heat for devolatilization.

14. The carbonaceous fuel gasification system of claim 1 wherein the indirect gasifier combustor is configured to utilize O₂/CO₂/syngas to produce the heat for gasification.

15. A carbonaceous fuel gasification system comprising:
a) a micronized char preparation system comprising a transport reactor with a pulverizer function that receives solid carbonaceous fuel, hydrogen, oxygen, and fluidizing steam, the micronized char preparation system producing micronized char, steam, and volatiles at an output; and
b) an indirect gasifier comprising:
i) a pressure vessel reactor;
ii) a dense bed of solids; and
iii) a combustor that provides heat for the gasification reaction by combustion of hydrogen and air and that provides products of combustion,
wherein the indirect gasifier mixing the micronized char with steam at a temperature that converts them to syngas comprising hydrogen and carbon monoxide.

16. The carbonaceous fuel gasification system of claim 15 wherein the micronized char preparation system is configured to utilize O₂/CO₂/syngas to produce the heat for devolatilization.

17. The carbonaceous fuel gasification system of claim 15 wherein the indirect gasifier combustor is configured to utilize O₂/CO₂/syngas to produce the heat for gasification.
